(19) United States
(12) Patent Application Publication
(10) Pub. No.: US 2026/0213550 A1
(43) Pub. Date: Jul. 23, 2026

(54) POWER FUSION SYSTEM AND HOUSEHOLD POWER SUPPLY SYSTEM

(71) Applicant: FranklinWH Energy Technology Inc., SANTA CLARA, CA (US)

(72) Inventors: Jiansheng CHEN, Shenzhen (CN); Tao WANG, Shenzhen (CN); Song CHEN, Shenzhen (CN)

(21) Appl. No.: 19/577,082

(22) Filed: Mar. 24, 2026

Related U.S. Application Data
(63) Continuation-in-part of application No. 18/112,282, filed on Feb. 21, 2023.

(51) Int. Cl. H02J 3/466; H02J 3/007; H02J 3/32; H02J 13/12; H02J 13/18; H02J 101/24; H02J 105/12

(52) U.S. Cl. CPC H02J 3/466; H02J 3/007; H02J 3/32; H02J 13/12; H02J 13/18; H02J 2101/24; H02J 2105/12

(57) ABSTRACT

A household power supply system includes a power supply, a household energy management center, and a power fusion system. The power supply includes one or more power supply sources. The household energy management center includes an energy management system (EMS) module, a meter socket adapter (MSA), an electric meter inserted in the MSA, and a distribution hub. The MSA includes a connection port for connecting a load. The EMS is arranged for managing and scheduling the one or more power supply sources. The distribution hub is arranged for connecting or disconnecting the one or more power supply sources. The power fusion system is connected to the household energy management center and the power supply, respectively and includes a control unit and one or more power supply modules. The one or more power supply modules are arranged for converting AC power or DC power into required AC power.

### CROSS-REFERENCE TO RELATED APPLICATION

This application is a continuation-in-part of application Ser. No. 18/112,282, filed Feb. 21, 2023, the disclosure of which is incorporated herein by reference in its entirety.

### TECHNICAL FIELD

The present disclosure relates to the technical field of power supply. In particular, the invention corresponds to a power fusion system, a power supply device, a power supply system, and a household power supply system.

### BACKGROUND

The existing power supply system supplies power through a public power supply network, but in some special circumstances (e.g., extreme weather), the power supply network is prone to failure, which results in the users unable to use electricity normally. Although the existing power supply system can provide power supply to the load, it needs a power supply matching with the load to supply power, which would lead to the problems that it is difficult to access the power supply of the household load, cannot meet the demand of long-term power reserve in extreme weather, and cannot solve the problem that multiple power supplies cooperate to supply power.

### BRIEF SUMMARY OF THE DISCLOSURE

The embodiment of the application provides a power fusion system, a power supply device and a power supply system, so as to solve the problem of high access difficulty caused by the fact that the power supply cannot match the power supply demand of load.

The embodiment of the application provides a power fusion system, including a control unit, at least one power conversion unit and a direct current (DC)/alternating current (AC) unit; the power conversion unit is configured to convert current output by a power supply into DC; the DC/AC unit is coupled with all installed power conversion units, and is configured to convert DC output by one or more power conversion units into AC that meets power supply demand; the control unit communicates with all installed power conversion units and the DC/AC unit, and is configured to control operation of one or more of the power conversion units and the DC/AC unit.

The embodiment of the application provides a power supply device, including a power fusion system and a distribution box; the power fusion system is coupled to the distribution box; the power fusion system includes a control unit, at least one power conversion unit and a DC/AC unit; the power conversion unit is configured to convert current output by a power supply into DC; the DC/AC unit is coupled with all installed power conversion units, and is configured to convert DC output by one or more power conversion units into AC that meets power supply demand; the control unit communicates with all installed power conversion units and the DC/AC unit, and is configured to control operation of one or more of the power conversion units and the DC/AC unit; the distribution box is configured to determine power supply demand, and allocate one or more power supplies connected with the power fusion system to supply power to a load according to the power supply demand.

The embodiment of the application provides a power supply system, including a distribution box, a power fusion system and at least one battery module; the distribution box is coupled with the power fusion system and the battery module; the power fusion system includes a control unit, at least one power conversion unit and a DC/AC unit; the power conversion unit is configured to convert current output by a power supply into DC; the DC/AC unit is connected with all installed power conversion units, and is configured to convert DC output by one or more power conversion units into AC that meets power supply demand; the control unit communicates with all installed power conversion units and the DC/AC unit, and is configured to control operation of one or more of the power conversion units and the DC/AC unit; the distribution box is configured to determine power supply demand, and allocate the power supply connected with the power fusion system according to the power supply demand, and the battery module supplies power to the load separately or jointly.

In the above power fusion system, the power supply device and the power supply system, the power fusion system can convert the current output by the power supply into AC that meets the power supply demand to supply power to the load, so that the power supply can be matched with the load corresponding to the power supply demand, the access difficulty of the power supply can be reduced, the long-term power reserve demand in extreme weather can be met, a plurality of power supplies can supply power cooperatively, the matching degree and adaptability of different power supplies can be improved, and the power consumption experience can be improved.

In an aspect, a household power supply system includes a power supply, a household energy management center, and a power fusion system. The power supply includes one or more power supply sources. The household energy management center includes an energy management system (EMS) module, a meter socket adapter (MSA), an electric meter inserted in the MSA, and a distribution hub. The MSA includes a connection port for connecting a load. The EMS is arranged for managing and scheduling the one or more power supply sources. The distribution hub is arranged for connecting or disconnecting the one or more power supply sources. The power fusion system is connected to the household energy management center and the power supply, respectively and includes a control unit and one or more power supply modules. The one or more power supply modules are arranged for converting AC power or DC power into required AC power.

In another aspect, a household power supply system includes a power supply, an EMS module, a distribution hub, and a power fusion system. The power supply at least includes an AC power supply source and a DC power supply source. The EMS module is arranged for managing and scheduling the AC and DC power supply sources. The distribution hub is arranged for connecting or disconnecting the AC or DC power supply source. The power fusion system is connected to the distribution hub and the power supply, respectively and includes a control unit, a first power supply module, and a second power supply module. The first and second power supply modules are arranged for converting AC power from the AC power supply source and DC power from the DC power supply source into required AC power, respectively.

In another aspect, a household power supply system includes a power supply, an EMS module, a distribution hub, an energy storage device, and a power fusion system. The power supply includes one or more power supply sources. The EMS module is arranged for managing and scheduling the one or more power supply sources and has an application (APP) interface and/or a web interface. The distribution hub is arranged for connecting or disconnecting the one or more power supply sources. The energy storage device includes a battery module and a power conversion system (PCS). The power fusion system is connected to the distribution hub and the power supply, respectively and includes a control unit and one or more power supply modules. The one or more power supply modules are arranged for converting AC power or DC power into required AC power.

Other aspects or embodiments of the present disclosure can be understood by those skilled in the art in light of the description, the claims, and the drawings of the present disclosure.

### BRIEF DESCRIPTION OF THE DRAWINGS

In order to illustrate the technical solutions in the embodiments of the present application or in the prior art more clearly, the following briefly introduces the accompanying drawings required for describing the embodiments or the prior art. It is obvious that the drawings in the following description only show some embodiments of the present application. A person of ordinary skill in the art can obtain other drawings according to the drawing without any creative effort.

FIG. 1 is a schematic diagram of a circuit powered by a power fusion system according to an embodiment of the present application.

FIG. 2 is a schematic diagram of another circuit powered by a power fusion system according to an embodiment of the present application.

FIG. 3 is a schematic diagram of a circuit powered by a power supply device according to an embodiment of the present application.

FIG. 4 is another schematic diagram of a circuit powered by a power supply device according to an embodiment of the present application.

FIG. 5 is a schematic diagram of a household power supply system including a power fusion system, a distribution hub, a power supply, and a panel according to embodiments of the present application.

FIG. 6 is a schematic diagram of a household power supply system including a power fusion system, a power supply, and a household energy management center according to embodiments of the present application.

### DETAILED DESCRIPTION

In the following, the technical solutions in the embodiments of the application will be clearly and completely described with reference to the drawings. It is apparent that the described embodiments are some but not all of the embodiments of the present application. All other embodiments obtained by a person of ordinary skill in the art without any creative effort on the basis of the embodiments in the present disclosure shall fall into the scope of the present disclosure. Wherever possible, the same reference numbers will be used throughout the drawings to refer to the same or like parts.

It is understood that the present disclosure may be embodied in many different forms and should not be construed as being limited to the embodiments set forth herein. Rather, these embodiments are provided so that this disclosure will be thorough and complete, and will fully convey the scope of the invention to those skilled in the art.

In order to make the present disclosure completely comprehensible, detailed steps and structures are provided in the following description. Preferred embodiments of the present application are described in detail below, however, besides these detailed descriptions, the present disclosure may involve other embodiments.

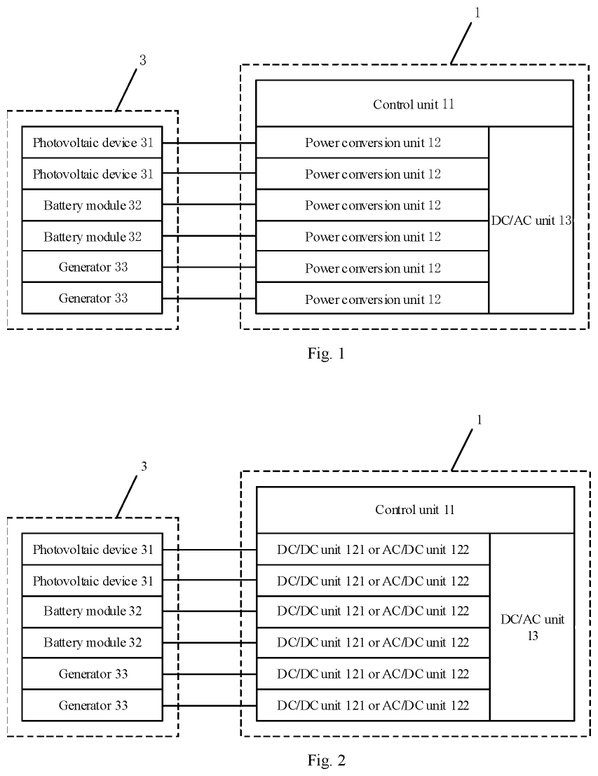

In an embodiment, as shown in FIG. 1, a power fusion system 1 is provided, including a control unit 11, at least one power conversion unit 12 and a DC/AC unit 13; the power conversion unit 12 is configured to convert the current output by the power supply 3 to DC; the DC/AC unit 13 is connected with all installed power conversion units 12, and is configured to convert DC output by one or more power conversion units 12 into AC that meets power supply demand; the control unit 11 communicates with all installed power conversion units 12 and DC/AC unit 13, and is configured to control operation of one or more power conversion units 12 and the DC/AC unit 13.

The control unit 11 is the unit used to realize signal control in power fusion system 1, which can realize the scheduling and coordination of the work of each module, and can perform various power protection, for example, power adjustment, proper selection of the power supply 3, and removal of faulty equipment. The power conversion unit 12 is a unit for realizing energy conversion, specifically converting the current output by the power supply 3 into DC output. The power supply 3 here includes but is not limited to a photovoltaic (PV) device 31, a battery module 32 and a generator 33. The DC/AC unit 13 is a unit for converting DC into AC.

As an example, the power fusion system 1 includes a control unit 11, a power conversion unit 12, and a DC/AC unit 13. The power conversion unit 12 can be connected to the power supply 3 to convert the current output by the power supply 3 into DC output. The DC/AC unit 13 is connected with a power conversion unit 12 and can convert the DC output from one power conversion unit 12 into AC that meets power supply demand. The DC/AC unit 13 can also be connected with the load 4 corresponding to power supply demand, so as to output the AC meeting the power supply demand to the load 4 and supply power to the load 4. The control unit 11 can communicate with an installed power conversion unit 12 and DC/AC unit 13, output control instructions to the power conversion unit 12 and DC/AC unit 13 and control the operation of the power conversion unit 12 and DC/AC unit 13.

As an example, the power fusion system 1 includes a control unit 11, a plurality of power conversion unit 12, and a DC/AC unit 13. The power conversion unit 12 can be connected to the power supply 3 to convert the current output by the power supply 3 into DC output. The DC/AC unit 13 is connected with a plurality of power conversion units 12 and can convert the DC output from the plurality of power conversion units 12 into AC that meets power supply demand. The DC/AC unit 13 may also be connected with the load 4 corresponding to the power supply demand, so as to output the AC meeting power supply demand to the load 4, which can realize that a plurality of power supplies 3 cooperate to supply power to the load 4. The control unit 11 can communicate with a plurality of installed power conversion units 12 and DC/AC unit 13, output control instructions to the power conversion unit 12 and DC/AC unit 13 and control the operation of the plurality of power conversion units 12 and DC/AC unit 13.

As an example, the power supply 3 connected to the power fusion system 1 may be a current source or a voltage source, and the power supply 3 may be dispatched to supply power to the load 4, and power adaptation can also be realized.

In this embodiment, the control unit 11 can communicate with all installed power conversion units 12 and DC/AC unit 13, and control one or more power conversion units 12 to convert the power supply 3 into DC. Then, DC/AC unit 13 is used to convert DC into AC that meets power supply demand, so that it can be matched with the load 4 corresponding to the power supply demand, which reduces access difficulty of power supply 3, meets the demand of long-term power reserve in extreme weather, enables multiple power supplies 3 to supply power cooperatively, improves the matching degree and adaptability of different power supplies 3, and improves the power consumption experience.

In an embodiment, as shown in FIG. 2, the power conversion unit 12 includes a DC/DC unit 121. The DC/DC unit 121 is configured to convert DC output from the power supply 3 into DC satisfying an input of the DC/AC unit 13.

As an example, the power conversion unit 12 can be a DC/DC unit 121, which is connected to the power supply 3, and can convert DC output from the connected power supply 3 into DC satisfying an input of the DC/AC unit 13. In this example, when the power supply 3 connected to the power fusion system 1 outputs DC (e. g., when the power supply 3 such as the photovoltaic device 31 or the battery module 32 outputs DC), the DC/DC unit 121 can convert DC output from the power supply 3 into DC that meets an output of the DC/AC unit 13, so that the DC/AC unit 13 can convert DC output from the DC/DC unit 121 into AC that meets the power supply demand to supply power to the load 4.

In an embodiment, as shown in FIG. 2, the power conversion unit 12 includes an AC/DC unit 122. The AC/DC unit 122 is configured to convert AC output by the power supply 3 into DC satisfying an input of the DC/AC unit 13.

As an example, the power conversion unit 12 may be an AC/DC unit 122, which is connected to the power supply 3, and can convert AC output from the connected power supply 3 into DC satisfying an input of the DC/AC unit 13. In this example, when the power supply 3 connected to the power fusion system 1 outputs AC (e. g., when the power supply 3 such as the generator 33, wind power, automobile V2H/V2L port outputs AC), the AC/DC unit 122 can convert AC output from the power supply 3 into DC that meets the output of the DC/AC unit 13, so that the DC/AC unit 13 can convert DC output by the AC/DC unit 122 into AC that meets the power supply demand to supply power to the load 4.

As an example, the input end of power fusion system 1 is designed in a modular way. Users can reasonably select DC/DC unit 121 or AC/DC unit 122 according to the characteristics of the power supply 3 actually connected. After determining the power conversion unit 12, according to the power supply demand, users can choose to connect one power supply 3 for power supply alone or connect multiple power supplies 3 together to supply power cooperatively, so as to ensure the output of AC meeting the power supply demand.

In an embodiment, the DC/AC unit 13 is a bidirectional DC/AC unit, and the power conversion unit 12 is a bidirectional power conversion unit. The bidirectional DC/AC unit and the bidirectional power conversion unit are configured to charge the energy storage power supply according to a charging instruction if the power supply 3 connected to the bidirectional power conversion unit is an energy storage power supply.

The bidirectional DC/AC unit is a unit that can convert DC to AC or convert AC to DC. Bidirectional power conversion unit is a unit that can realize bidirectional power conversion. The energy storage power supply refers to a power supply that can store energy, for example, the battery module 32.

As an example, when the DC/AC unit 13 is a bidirectional DC/AC unit and the power conversion unit 12 is a bidirectional power conversion unit, if the power supply 3 connected to the bidirectional power conversion unit is an energy storage power supply, that is, it has the characteristics of storing energy, the bidirectional DC/AC unit and the bidirectional power conversion unit can charge the energy storage power supply connected to the power fusion system 1 through the main electricity grid 34 or other power supply 3 according to the received charging instruction. Furthermore, the control unit 11 can also manage the energy storage power supply connected to the power fusion system 1.

In an embodiment, the control unit 11 is configured to add power supply 3 if the sum of the power output from all the power supplies 3 cannot meet power supply demand.

As an example, in the process of control and allocation, the control unit 11 needs to detect whether the sum of the power output from all the power supplies 3 meets the power supply demand in real time. If it does not meet the power supply demand, it is determined that the power supplies 3 cannot supply power to all loads 4. At this time, more power supplies 3 may be added to make more power supplies 3 work together to supply power to the load 4. In this example, if the sum of the power output from all the power supplies 3 cannot meet the power supply demand, the control unit 11 can automatically start the power supply 3 connected to the power fusion system 1 but not yet started, so as to add the power supply 3 to supply power to the loads 4, ensure the normal operation of all loads 4 and improve the power consumption experience.

In an embodiment, the control unit 11 is configured to perform fault detection on all power supplies 3 in power supply, and control to disconnect the failed power supply 3.

As an example, the control unit 11 can further detect the faults of all the power supplies 3 in power supply, and if one or more power supplies 3 are detected to be faulty, it can control to disconnect the faulty power supplies 3, so that the faulty power supplies 3 would not affect the power supply of other modules, not affect the operation of the power supply system to which the power fusion system 1 belongs, and ensures the safety of electricity consumption.

In an embodiment, the control unit 11 is configured to detect the fault of the power conversion unit 12 at work and control to disconnect the failed power conversion unit 12.

As an example, the control unit 11 can further detect the faults of the power conversion units 12 at work, and if one or more power conversion units 12 are detected to have faults, the control unit 11 can control to disconnect the faulty power conversion units 12, so that the faulty power conversion unit 12 would not affect the power supply of other modules, and not affect the operation of the power supply system to which the power fusion system 1 belongs, and ensure the safety of electricity consumption.

In an embodiment, the power fusion system 1 further includes a DC bus; all installed power conversion units 12 are connected with the DC bus in parallel; the DC/AC unit 13 is connected to the DC bus.

As an example, the power fusion system 1 is provided with a DC bus, all the installed power conversion units 12 in the power fusion system 1 are connected in parallel with the DC bus, and the DC/AC unit 13 is connected with the DC bus, so that all the installed power conversion unit 12 can convert the current output by one or more power supplies 3 into DC and transmit it to the DC bus, and the DC/AC unit 13 converts the DC in the DC bus into AC output, so as to ensure the coordinated power supply of multiple power supplies 3 and improve the power consumption experience.

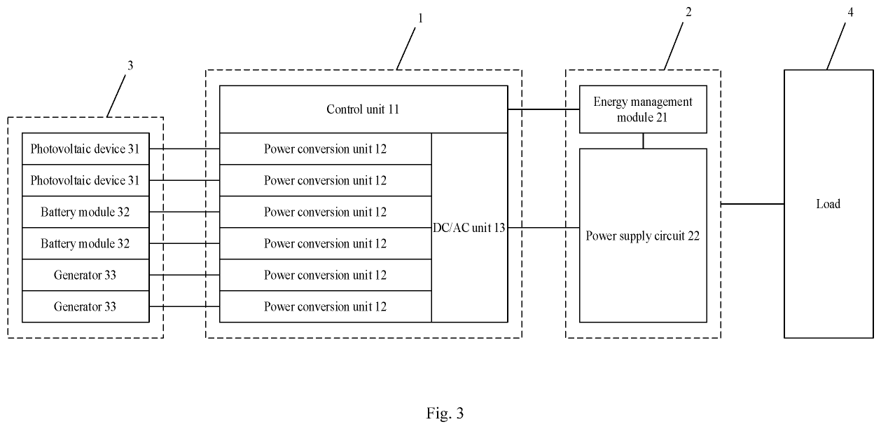

In an embodiment, as shown in FIG. 3, a power supply device is provided, including a power fusion system 1 and a distribution box 2. Power fusion system 1 may be connected to the distribution box 2. The power fusion system 1 includes a control unit 11, at least one power conversion unit 12 and a DC/AC unit 13. The power conversion unit 12 is configured to convert the current output by the power supply 3 into DC. The DC/AC unit 13 is connected to all installed power conversion units 12 and is configured to convert DC output by one or more power conversion units 12 into AC that meets power supply demand. The control unit 11 can communicate with all the installed power conversion units 12 and DC/AC unit 13, and is configured to control the operation of one or more power conversion units 12 and DC/AC unit 13.

The distribution box 2 is configured to determine the power supply demand, and allocate one or more power supplies 3 connected to the power fusion system 1 to supply power to the load 4 according to the power supply demand.

The distribution box 2 is the energy management center, which is responsible for energy dispatching and management.

As an example, the distribution box 2 can determine power supply demand of all loads 4 according to the loads 4 connected to the distribution box 2, and allocate one or more power supplies 3 connected to the power fusion system 1 to supply power to the loads 4 according to the power supply demand. In this example, the distribution box 2 communicates with the control unit 11 in the power fusion system 1 and sends the determined power supply demand to the control unit 11, so as to enable the control unit 11 to allocate one or more power supplies 3 connected with the power fusion system 1 to supply power to the load 4, and specifically the power conversion unit 12 connected with one or more power supplies 3 is controlled to perform energy conversion on the current output by the power supplies 3 into DC, so as to convert the power supplies 3 into DC, and the DC/AC unit 13 is used for converting DC into AC that meets the power supply demand to supply power to the load 4, so that the power supplies 3 are matched with the load 4, the access difficulty of the power supplies 3 is reduced, and the long-time standby demand in extreme weather is met; and it enables a plurality of power supplies 3 to supply power cooperatively, improves the matching degree and the adaptability of different power supplies 3, and improves the power consumption experience.

In an embodiment, as shown in FIG. 3, the distribution box 2 includes an energy management module 21 and a power supply circuit 22. The input end of the power supply circuit 22 may be connected to the power fusion system 1, and the output end of the power supply circuit 22 may be connected to the load 4. The energy management module 21 can communicate with the power fusion system 1 and the power supply circuit 22, and is configured to determine the power supply demand, and allocate one or more power supplies 3 connected to the power fusion system 1 to supply power to the load 4 according to the power supply demand.

The energy management module 21 is used to realize energy management, and is responsible for energy dispatching and management. The energy management module 21 is the core of energy dispatching for the power supply device, and is responsible for the management and control of the power supply system to which the power supply device belongs, and can formulate reasonable energy dispatching management strategies according to the actual power supply demand. In this example, the energy management module 21 mainly includes a communication interface (including but not limited to CAN communication, RS485 communication, WLAN communication, Wi-Fi and 4G, etc.), relay control interface and relay detection interface functions, grid voltage detection, circuit detection, current and voltage detection of each input and output branch, and control strategy logic, etc.

The power supply circuit 22 is a circuit for realizing power supply.

As an example, the input end of the power supply circuit 22 can be connected to the power fusion system 1, and the output end of the power supply circuit 22 can be connected to the load 4. When the power supply circuit 22 is switched on, the load 4 can be powered by the AC output from the power fusion system 1 to meet the power supply demand, so as to achieve the purpose of using one or more power supplies 3 connected to the power fusion system 1 to power the load 4.

As an example, the energy management module 21 can communicate with the power fusion system 1 and the power supply circuit 22, and can determine the power supply demand of all loads 4 according to the loads 4 connected to the distribution box 2. The power supply demand is sent to the control unit 11 of the power fusion system 1, so that the control unit 11 allocates one or more power supplies 3 connected to the power fusion system 1 to supply power to the load 4, so as to control the one or more power supplies 3 to supply power to the load 4 cooperatively and improve the power consumption experience.

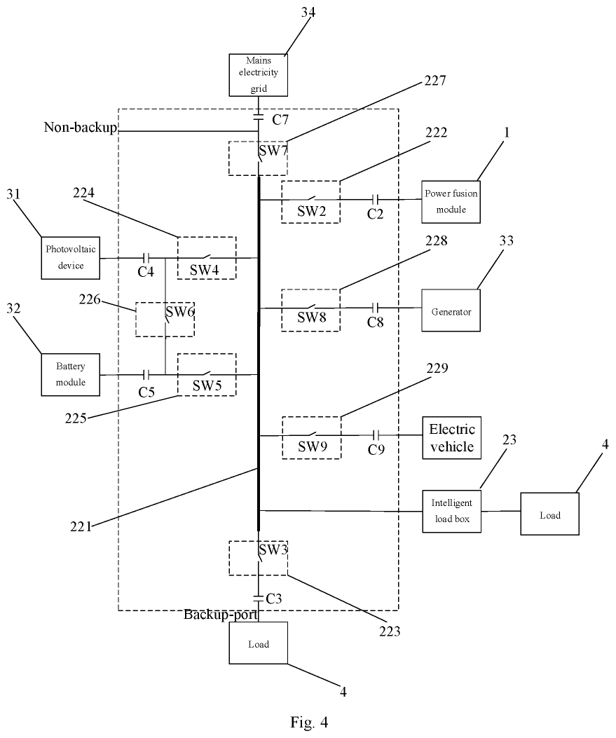

In an embodiment, as shown in FIG. 4, the power supply circuit 22 includes a power supply bus 221 and a fusion switch circuit 222. The output end of the fusion switch circuit 222 is connected with the power supply bus 221, and the input end of the fusion switch circuit 222 can be connected with the power fusion system 1. The energy management module 21 can communicate with the fusion switch circuit 222 and is configured to control the on-off of the fusion switch circuit 222.

The power supply bus 221 is a bus arranged in the distribution box 2 for realizing power supply function. The fusion switch circuit 222 is a switch circuit for connecting the power fusion system 1.

As an example, the input end of the fusion switch circuit 222 can be connected to the power fusion system 1, and the output end of the fusion switch circuit 222 can be connected to the power supply bus 221. The energy management module 21 can communicate with the fusion switch circuit 222 and can control the on-off of the fusion switch circuit 222 according to actual demand.

In this example, the energy management module 21 can control the fusion switch circuit 222 to turn on when it needs to allocate one or more power supplies 3 connected to the power fusion system 1 to supply power to the load 4. Conversely, the energy management module 21 can control the fusion switch circuit 222 to turn off when it does not need to allocate one or more power supplies 3 connected to the power fusion system 1 to supply power to the load 4. In this example, the energy management module 21 can communicate with the power fusion system 1 to realize data exchange and power dispatching.

As shown in FIG. 4, the fusion switch circuit 222 includes a switch SW2, one end of the switch SW2 is connected to the power fusion system 1, and the other end of the switch SW2 is connected to the power supply bus 221. The energy management module 21 can control the switch SW2 to be on when the power supply 3 connected to the power fusion system 1 is needed for power supply. Conversely, the energy management module 21 can control the switch SW2 to be off when the power supply 3 connected to the power fusion system 1 is not needed for power supply. In this example, the power supply circuit 22 further includes a capacitor C2, one end of the capacitor C2 can be connected to the power fusion system 1, and the other end of the capacitor C2 can be connected to the switch SW2, so as to realize the function of DC blocking and AC passing.

In an embodiment, the energy management module 21 is configured to perform fault detection on the power fusion system 1, and control the fusion switch circuit 222 to disconnect if the power fusion system 1 has a fault.

As an example, the energy management module 21 can further perform fault detection on the power fusion system 1. When the power fusion system 1 has a fault, the fusion switch circuit 222 can be controlled to be switched off. For example, the switch SW2 shown in FIG. 4 can be controlled to be off, so that the failed power fusion system 1 would not affect the power supply of other modules, and would not affect the normal operation of the power supply system, and ensure the safety of electricity consumption.

In an embodiment, as shown in FIG. 4, the power supply circuit 22 includes a power supply bus 221 and a load switch circuit 223. The input end of the load switch circuit 223 is connected to the power supply bus 221, and the output end of the load switch circuit 223 can be connected to the load 4. The energy management module 21 can communicate with the load switch circuit 223 and is configured to control the on-off of the load switch circuit 223.

The load switch circuit 223 is a switch circuit for connecting the load 4.

As an example, the input end of the load switch circuit 223 is connected to the power supply bus 221, and the output end of the load switch circuit 223 can be connected to the load 4. The energy management module 21 can communicate with the load switch circuit 223, and control the on-off of the load switch circuit 223 according to actual needs. In this example, when it needs to supply power to one or more loads 4 connected to the distribution box 2, the load switch circuit 223 to which the one or more loads 4 belong can be controlled to be switched on to supply power to the loads 4 through the power supply bus 221. Conversely, when it does not need to supply power to one or more loads 4 connected to the distribution box 2, the load switch circuit 223 to which the one or more loads 4 belong can be controlled to be disconnected.

In an embodiment, as shown in FIG. 4, the power supply circuit 22 includes a power supply bus 221 and a photovoltaic switch circuit 224. The input end of photovoltaic switch circuit 224 is connected to a photovoltaic device 31, and the output end of photovoltaic switch circuit 224 is connected to the power supply bus 221. The energy management module 21 can communicate with the photovoltaic switch circuit 224, and is configured to control the on-off of the photovoltaic switch circuit 224.

The photovoltaic switch circuit 224 is a switch circuit for connecting the photovoltaic device 31.

As an example, the input of the photovoltaic switch circuit 224 is connected to the photovoltaic device 31, and the output of the photovoltaic switch circuit 224 is connected to the power supply bus 221. The energy management module 21 can communicate with the photovoltaic switch circuit 224, and can control the photovoltaic switch circuit 224 to be switched on according to actual demand. In this example, when it needs to connect the photovoltaic device 31 to the power supply bus 221 as the power supply 3 to supply power to the load 4 connected to the power supply bus 221 and supply power to the energy storage power supply (such as the battery module 32), the photovoltaic switch circuit 224 can be controlled to be turned on. Conversely, when it does not need to connect the photovoltaic device 31 as the power supply 3 to the power supply bus 221 to supply power to the load 4 connected to the power supply bus 221 or supply power to the energy storage power supply, the photovoltaic switch circuit 224 can be controlled to be turned off.

As shown in FIG. 4, the photovoltaic switch circuit 224 includes a switch SW4, one end of the switch SW4 is connected to the photovoltaic device 31, and the other end of the switch SW4 is connected to the power supply bus 221. When the photovoltaic device 31 needs to be connected to the distribution box 2 for power supply, the energy management module 21 can control the switch SW4 to be turned on. Conversely, when the photovoltaic device 31 does not need to be connected to the distribution box 2 for power supply, the energy management module 21 can control the switch SW4 to be turned off. In this example, the power supply circuit 22 further includes a capacitor C4. One end of the capacitor C4 can be connected to the photovoltaic device 31, and the other end of the capacitor C2 can be connected to the switch SW4, which can realize the function of DC blocking and AC passing.

In practical application, one or more photovoltaic devices 31 can be connected to the distribution box 2 through the photovoltaic switch circuit 224. For example, the currents output by a plurality of photovoltaic devices 31 may be converged and then connected to the power supply bus 221 through a photovoltaic switch circuit 224. Or, each photovoltaic device 31 can be connected to the power supply bus 221 through a photovoltaic switch circuit 224, so that the plurality of photovoltaic devices 31 can output current to the power supply bus 221 to supply power to the load 4 or the energy storage power supply connected to the distribution box 2. Understandably, after the plurality of photovoltaic device 31 are connected to the distribution box 2, the plurality of photovoltaic switch circuit 224 may be controlled separately or in groups through the energy management module 21.

In an embodiment, as shown in FIG. 4, the power supply circuit 22 includes a power supply bus 221 and a battery switch circuit 225. The input end of the battery switch circuit 225 is connected to a battery module 32, and the output end of the battery switch circuit 225 is connected to the power supply bus 221. The energy management module 21 can communicate with the battery switch circuit 225, and is configured to control the on-off of the battery switch circuit 225. The battery switch circuit 225 is a switch circuit for connecting the battery module 32.

As an example, the input of the battery switch circuit 225 is connected to the battery module 32, and the output of the battery switch circuit 225 is connected to the power supply bus 221. The energy management module 21 can communicate with the battery switch circuit 225, and can control the battery switch circuit 225 to be switched on according to actual demand. In this example, when the battery module 32 needs to be connected to the power supply bus 221 as the power supply 3 to supply power to the load 4 connected to the power supply bus 221, the battery switch circuit 225 can be controlled to be turned on. Conversely, when it does not need to connect the battery module 32 as the power supply 3 to the power supply bus 221 to supply power to the load 4 connected to the power supply bus 221, the battery switch circuit 225 can be controlled to be turned off.

As shown in FIG. 4, the battery switch circuit 225 includes a switch SW5, one end of the switch SW5 can be connected to one or more battery modules 32, and the other end of the switch SW5 is connected to the power supply bus 221. When one or more battery modules 32 need to be connected to the distribution box 2, the switch SW5 can be controlled to be turned on; when one or more battery modules 32 do not need to be connected to the distribution box 2, the switch SW5 can be controlled to be turned off. In this example, the power supply circuit 22 further includes a capacitor C5, one end of the capacitor C5 can be connected to the battery module 32, and the other end of the capacitor C5 can be connected to the switch SW5, so as to realize the function of DC blocking and AC passing.

In practical application, one or more battery modules 32 can be connected to the distribution box 2 through the battery switch circuit 225. For example, the currents output by a plurality of battery module 32 can be converged and then connected to the power supply bus 221 through a battery switch circuit 225. Or, each battery module 32 can be connected to the power supply bus 221 through a battery switch circuit 225, so that the plurality of battery modules 32 can output current to the power supply bus 221 to supply power to the load 4 connected to the distribution box 2. Understandably, after the plurality of battery modules 32 are connected to the distribution box 2, the energy management module 21 can control the operation of the plurality of battery modules 32 separately or in groups.

In an embodiment, as shown in FIG. 4, the power supply circuit 22 includes a power supply bus 221, a photovoltaic switch circuit 224, a battery switch circuit 225 and a charging start circuit 226. The input end of the photovoltaic switch circuit 224 can be connected to the photovoltaic device 31, and the output end of the photovoltaic switch circuit 224 is connected to the power supply bus 221. The input end of battery switch circuit 225 can be connected to one or more battery modules 32, and the output end of battery switch circuit 225 is connected to the power supply bus 221. The input end of the charging start circuit 226 is connected to the node between the photovoltaic switch circuit 224 and the photovoltaic device 31, and the output end of the charging start circuit 226 is connected to the node between the battery switch circuit 225 and the battery module 32. The energy management module 21 can communicate with the photovoltaic switch circuit 224, the battery switch circuit 225 and the charging start circuit 226, respectively, and is configured to, control the photovoltaic switch circuit 224 and the battery switch circuit 225 to be switched off, and control the charging start circuit 226 to be switched on, so that the photovoltaic device 31 can charge one or more battery modules 32.

The charging start circuit 226 is a switch circuit for controlling the startup of the photovoltaic device 31.

As an example, the power supply circuit 22 includes not only photovoltaic switch circuit 224 and battery switch circuit 225, but also charging start circuit 226. The input end of the photovoltaic switch circuit 224 can be connected to the photovoltaic device 31, and the output end of the photovoltaic switch circuit 224 is connected to the power supply bus 221, so that the current output by the photovoltaic device 31 can be transmitted to the power supply bus 221. The input end of the battery switch circuit 225 can be connected to one or more battery modules 32, and the output end of the battery switch circuit 225 is connected to the power supply bus 221, so that the current output by one or more battery modules 32 can be transmitted to the power supply bus 221. The input end of the charging start circuit 226 is connected to the node between the photovoltaic switch circuit 224 and the photovoltaic device 31, the output end of the charging start circuit 226 is connected to the node between the battery switch circuit 225 and the battery module 32, so that when the charging start circuit 226 is turned on, the photovoltaic device 31 can charge one or more battery modules 32.

In this example, the energy management module 21 can communicate with the photovoltaic switch circuit 224, battery switch circuit 225 and charging start circuit 226. When the photovoltaic device 31 needs to be started to supply power to one or more battery modules 32 connected to the distribution box 2, the photovoltaic switch circuit 224 and the battery switch circuit 225 can be controlled to be disconnected, the charging start circuit 226 is controlled to be turned on, so that a path is formed between the photovoltaic device 31 and one or more battery modules 32, so that the photovoltaic device 31 can charge one or more battery modules 32. Under extreme conditions, for example, when the load 4 connected to the distribution box 2 is heavy, the energy output by the photovoltaic device 31 is weak, and the main electricity grid 34 is out of power, one or more battery modules 32 cannot meet the power supply demand. In this case, the photovoltaic switch circuit 224 and the battery switch circuit 225 can be controlled to be turned off, and the charging start circuit 226 can be controlled to be turned on to start one or more battery modules 32 as voltage sources. Thus, the photovoltaic device 31 can be started, and one or more battery modules 32 can be charged under the illumination, so that the charging efficiency and energy utilization rate are improved, and the difficulty of photovoltaic start-up under extreme conditions is reduced.

As shown in FIG. 4, the photovoltaic switch circuit 224 includes a switch SW4, one end of the switch SW4 is connected to the photovoltaic device 31, and the other end of the switch SW4 is connected to the power supply bus 221. The battery switch circuit 225 includes a switch SW5, one end of the switch SW5 can be connected to one or more battery modules 32, and the other end of the switch SW5 is connected to the power supply bus 221. The power supply circuit 22 further includes a capacitor C4 arranged between the photovoltaic device 31 and the switch SW4, and a capacitor C5 arranged between the battery module 32 and the switch SW5. The charging start circuit 226 includes a switch SW6, one end of the switch SW6 is connected to the node between the capacitor C5 and the switch SW5, and the other end of the switch SW6 is connected to the node between the capacitor C4 and the switch SW5. The energy management module 21 is connected with a switch SW4, a switch SW5 and a switch SW6. When it needs to control the photovoltaic device 31 to be connected to the power supply bus 221 as the power supply 3, the switch SW4 can be controlled to be on. When it needs to control one or more battery modules 32 to be connected to the power supply bus 221 as the power supply 3, the switch SW5 can be controlled to be on. When the photovoltaic device 31 needs to be controlled to charge one or more battery modules 32, the switch SW4 and switch SW5 can be controlled to be off, and the switch SW6 can be controlled to be on, so that the battery module 32 can supply power to the photovoltaic device 31 first, thus the photovoltaic device 31 is started to work. Under the condition of illumination, the photovoltaic device 31 charges one or more battery modules 32, thereby improving the charging efficiency and energy utilization rate and reducing the difficulty of photovoltaic starting under extreme conditions.

In an embodiment, as shown in FIG. 4, the power supply circuit 22 includes a power supply bus 221 and a main switch circuit 227. The input end of the main switch circuit 227 is connected to a main electricity grid 34, and the output end of the main switch circuit 227 is connected to the power supply bus 221. The energy management module 21 can communicate with the main switch circuit 227, and is configured to control the on-off of the main switch circuit 227.

The main switch circuit 227 is a switch circuit for connecting main electricity grid 34.

As an example, the input end of main switch circuit 227 can be connected to the main electricity grid 34, and the output end of the main switch circuit 227 is connected to the power supply bus 221. The energy management module 21 can communicate with the main switch circuit 227, and control the main switch circuit 227 to be switched on according to actual demand. In this example, when it needs to connect the main electricity grid 34 as the power supply 3 to the power supply bus 221 to supply power to the load 4 connected to the power supply bus 221, the main switch circuit 227 may be controlled to be switched on. Conversely, when it does not need to connect the main electricity grid 34 as the power supply 3 to the power supply bus 221, the main switch circuit 227 can be controlled to be switched off, so as to supply power to the load 4 connected to the power supply bus 221 through other power supply 3 other than the main electricity grid 34. For example, when off-grid power is needed, the main switch circuit 227 can be controlled to be disconnected, and the power supply of main electricity grid 34 can be cut off.

As shown in FIG. 4, the main switch circuit 227 includes a switch SW7. One end of the switch SW7 can be connected to the main electricity grid 34, the other end of the switch SW7 is connected to the power supply bus 221, and the energy management module 21 communicates with the switch SW7. When the main electricity grid 34 is powered on, the switch SW7 can be controlled to be closed, so that the main electricity grid 34 is connected to the power supply bus 221 to supply power to the load 4 connected to the power supply bus 221. Alternatively, when the main electricity grid 34 is powered on, if the photovoltaic device 31 or the battery module 32 has sufficient energy to connect the power supply bus 221 and meet the power supply demand of all loads 4, the switch SW7 may also be controlled to be off to supply power to the load 4 through the photovoltaic device 31 or the battery module 32. Alternatively, when the main electricity grid 34 is powered off, the switch SW7 can be controlled to off, so as to supply power to the load 4 through the photovoltaic device 31, the battery module 32 or other power supplies 3. In this example, the power supply circuit 22 further includes a capacitor C7. One end of the capacitor C7 can be connected to the main electricity grid 34, and the other end of the capacitor C7 is connected to the switch SW7, so as to realize the function of DC blocking and AC passing.

In an embodiment, as shown in FIG. 4, the power supply circuit 22 includes a power supply bus 221, a main switch circuit 227 and a photovoltaic switch circuit 224. The input end of the main switch circuit 227 can be connected to the main electricity grid 34, and the output end of the main switch circuit 227 is connected to the power supply bus 221. The input end of the photovoltaic switch circuit 224 can be connected to the photovoltaic device 31, and the output end of the photovoltaic switch circuit 224 is connected to the power supply bus 221. The energy management module 21 can communicate with the main switch circuit 227 and the photovoltaic switch circuit 224, respectively, and is configured to, control the main switch circuit 227 and the photovoltaic switch circuit 224 to be switched on, so that the photovoltaic device 31 feeds back electric energy to the main electricity grid 34.

As an example, the input end of the main switch circuit 227 can be connected to the main electricity grid 34, and the output end of the main switch circuit 227 is connected to the power supply bus 221. The input end of photovoltaic switch circuit 224 is connected to photovoltaic device 31, and the output end of photovoltaic switch circuit 224 is connected to the power supply bus 221. The energy management module 21 communicates with the main switch circuit 227 and the photovoltaic switch circuit 224. If the main electricity grid 34 connected to the distribution box 2 can receive the electric energy feedback, the energy management module 21 can control the main switch circuit 227 and the photovoltaic switch circuit 224 to be switched on, so as to feed back the electric energy generated by the photovoltaic device 31 to the main electricity grid 34 to achieve the purpose of energy saving.

As shown in FIG. 4, the photovoltaic switch circuit 224 includes a switch SW4. One end of the switch SW4 is connected to the photovoltaic device 31, and the other end of the switch SW4 is connected to the power supply bus 221. The main switch circuit 227 includes a switch SW7, one end of the switch SW7 can be connected to main electricity grid 34, and the other end of the switch SW7 is connected to the power supply bus 221. The energy management module 21 communicates with the switch SW4 and switch SW7, and can control the switch SW4 and switch SW7 to be on when the main electricity grid 34 can receive the electric energy feedback, so that the photovoltaic device 31 can feed back the electric energy to the main electricity grid 34. The energy management module 21 is in communication with the switch SW4 and switch SW7. If the main electricity grid 34 can receive electric energy feedback, and there is still excess energy after the photovoltaic device 31 supplies power to the load 4 connected to the power supply bus 221, the switch SW4 and switch SW7 can be controlled to be on, so that the photovoltaic device 31 can feed back the excess electric energy to the main electricity grid 34.

In an embodiment, as shown in FIG. 4, the power supply circuit 22 includes a power supply bus 221, a main switch circuit 227 and a photovoltaic switch circuit 224. The input end of the main switch circuit 227 can be connected to the main electricity grid 34, and the output end of the main switch circuit 227 is connected to the power supply bus 221. The input end of the photovoltaic switch circuit 224 can be connected to the photovoltaic device 31, and the output end of the photovoltaic switch circuit 224 is connected to the power supply bus 221. The energy management module 21 can communicate with the main switch circuit 227 and photovoltaic switch circuit 224, respectively, and is configured to, detect the photovoltaic device 31, and control the main switch circuit 227 to be switched off and the photovoltaic switch circuit 224 to be switched on if the power supply capacity of the photovoltaic device 31 meets the power supply demand.

As an example, the input end of the main switch circuit 227 can be connected to the main electricity grid 34, and the output end of the main switch circuit 227 is connected to the power supply bus 221. The input end of photovoltaic switch circuit 224 is connected to photovoltaic device 31, and the output end of photovoltaic switch circuit 224 is connected to the power supply bus 221. The energy management module 21 communicates with the main switch circuit 227 and photovoltaic switch circuit 224, and can perform detection on the photovoltaic device 31 to determine power supply capacity of the photovoltaic device 31. When the power supply capacity of the photovoltaic device 31 meets the power supply demand of all loads 4, the main switch circuit 227 can be controlled to be switched off and the photovoltaic switch circuit 224 can be controlled to be switched on, so that main electricity grid 34 is not connected to the power supply bus 221 to supply power to load 4, and the photovoltaic device 31 is connected to the power supply bus 221 to supply power to load 4, so as to achieve the purpose of adopting photovoltaic device 31, a green power supply, to achieve energy conservation and environmental protection.

As shown in FIG. 4, the photovoltaic switch circuit 224 includes a switch SW4. One end of the switch SW4 is connected to the photovoltaic device 31, and the other end of the switch SW4 is connected to the power supply bus 221. The main switch circuit 227 includes a switch SW7, one end of the switch SW7 can be connected to main electricity grid 34, and the other end of the switch SW7 is connected to the power supply bus 221. The energy management module 21 communicates with the switch SW4 and switch SW7. When it is detected that the power supply capacity of the photovoltaic device 31 meets the power supply demand of all loads 4, it can control the switch SW7 to be off, and control the switch SW4 to be on, so as to turn off the main electricity grid 34, and use the photovoltaic device 31 to supply power to the load 4, so that the purposes of energy conservation and environmental protection are achieved.

In an embodiment, as shown in FIG. 4, the power supply circuit 22 includes a power supply bus 221, a main switch circuit 227 and a battery switch circuit 225. The input end of the main switch circuit 227 can be connected to the main electricity grid 34, and the output end of the main switch circuit 227 is connected to the power supply bus 221. The input end of the battery switch circuit 225 can be connected to one or more battery modules 32, and the output end of the battery switch circuit 225 is connected to the power supply bus 221. The energy management module 21 can communicate with the main switch circuit 227 and battery switch circuit 225, respectively, and is configured to, detect the battery module 32, and control the main switch circuit 227 to be switched off and the battery switch circuit 225 to be switched on if the power supply capacity of the battery module 32 meets the power supply demand.

As an example, the input end of the main switch circuit 227 can be connected to the main electricity grid 34, and the output end of the main switch circuit 227 is connected to the power supply bus 221, so as to supply power to the load 4 through the main electricity grid 34. The input end of battery switch circuit 225 can be connected to one or more battery modules 32, and the output end of battery switch circuit 225 is connected to the power supply bus 221. The energy management module 21 communicates with the main switch circuit 227 and the battery switch circuit 225. The energy management module 21 can detect one or more battery modules 32 to determine the power supply capacity of one or more battery modules 32. When the power supply capacity of the battery module 32 meets the power supply demand of all loads 4, the main switch circuit 227 can be controlled to be switched off and the battery switch circuit 225 can be controlled to be switched on, so that the main electricity grid 34 is not connected to the power supply bus 221 to supply power to the load 4, and the one or more battery modules 32 are connected to the power supply bus 221 to supply power to the load 4, so that the battery module 32, a green power supply, can be used to supply power, and the purposes of energy conservation and environmental protection can be achieved.

As shown in FIG. 4, the battery switch circuit 225 includes a switch SW5. One end of the switch SW5 is connected to one or more battery modules 32, and the other end of the switch SW5 is connected to the power supply bus 221. The main switch circuit 227 includes a switch SW7, one end of the switch SW7 can be connected to main electricity grid 34, and the other end of the switch SW7 is connected to the power supply bus 221. The energy management module 21 can communicate with the switch SW5 and switch SW7. When it is detected that the power supply capacity of the battery module 32 meets the power supply demand of all loads 4, it can control the switch SW7 to be off, and control the switch SW5 to be on, so as to turn off the main electricity grid 34, and use the battery module 32 to supply power to the load 4, so that the purposes of energy conservation and environmental protection are achieved.

In an embodiment, as shown in FIG. 4, the power supply circuit 22 includes a power supply bus 221, a main switch circuit 227, a photovoltaic switch circuit 224 and a battery switch circuit 225. The input end of main switch circuit 227 can be connected to the main electricity grid 34, and the output end of main switch circuit 227 is connected to the power supply bus 221. The input end of the photovoltaic switch circuit 224 can be connected to the photovoltaic device 31, and the output end of the photovoltaic switch circuit 224 is connected to the power supply bus 221. The input end of battery switch circuit 225 can be connected to one or more battery modules 32, and the output end of the battery switch circuit 225 is connected to the power supply bus 221. The energy management module 21 can communicate with the main switch circuit 227, the photovoltaic switch circuit 224 and the battery switch circuit 225, respectively, and is configured to, detect the photovoltaic device 31 and battery module 32, and if the sum of the power supply capacities of the photovoltaic device 31 and battery module 32 meets the power supply demand, control the main switch circuit 227 to be switched off, the photovoltaic switch circuit 224 to be switched on and the battery switch circuit 225 to be switched on.

As an example, the input end of the main switch circuit 227 can be connected to the main electricity grid 34, and the output end of the main switch circuit 227 is connected to the power supply bus 221. The input end of photovoltaic switch circuit 224 is connected to photovoltaic device 31, and the output end of photovoltaic switch circuit 224 is connected to power supply bus 221. The input end of battery switch circuit 225 can be connected to one or more battery modules 32, and the output end of battery switch circuit 225 is connected to power supply bus 221. The energy management module 21 communicates with the main switch circuit 227, photovoltaic switch circuit 224 and battery switch circuit 225, the energy management module 21 can detect the photovoltaic device 31 and battery module 32 to determine the power supply capacity of the photovoltaic device 31 and battery module 32. When the sum of the power supply capacity of the photovoltaic device 31 and the power supply capacity of the battery module 32 meets the power supply demand of all loads 4, the main switch circuit 227 can be controlled to be switched off, the photovoltaic switch circuit 224 can be controlled to be switched on, and the battery module 32 can be controlled to be switched on, so that the main electricity grid 34 is not connected to power supply bus 221 to supply power to the load 4, but the photovoltaic device 31 and battery module 32 are connected to the power supply bus 221 to supply power to the load 4, so as to achieve the purpose of energy saving and environmental protection by using green power sources such as photovoltaic device 31 and battery module 32.

As shown in FIG. 4, the photovoltaic switch circuit 224 includes a switch SW4, one end of the switch SW4 is connected to the photovoltaic device 31, and the other end of the switch SW4 is connected to the power supply bus 221. The battery switch circuit 225 includes a switch SW5, one end of the switch SW5 can be connected to one or more battery modules 32, and the other end of the switch SW5 is connected to the power supply bus 221. The main switch circuit 227 includes a switch SW7, one end of the switch SW7 can be connected to the main electricity grid 34, and the other end of the switch SW7 is connected to the power supply bus 221. The energy management module 21 communicates with the switch SW4, switch SW5 and switch SW7. When it is detected that the sum of the power supply capacity of the photovoltaic device 31 and the power supply capacity of the battery module 32 meets the power supply demand of all loads 4, the switch SW7 can be controlled to be off, and the switch SW4 and switch SW5 can be controlled to be on, so as to disconnect the main electricity grid 34, and use the photovoltaic device 31 and battery module 32 to supply power to the load 4, thus achieving the purpose of energy saving and environmental protection.

In an embodiment, as shown in FIG. 4, the power supply circuit 22 includes a power supply bus 221 and a generator switch circuit 228. The input end of the generator switch circuit 228 can be connected to a generator 33, and the output end of the generator switch circuit 228 is connected to the power supply bus 221. The energy management module 21 can communicate with the generator switch circuit 228, and is configured to control the on-off of the generator switch circuit 228.

The generator switch circuit 228 is a switch circuit for connecting the generator 33.

As an example, the input end of the generator switch circuit 228 can be connected to the generator 33, and the output end of the generator switch circuit 228 is connected to the power supply bus 221, so as to switch the generator 33 to output electric energy to the power supply bus 221. The energy management module 21 can communicate with the generator switch circuit 228, and can control the on-off of the generator switch circuit 228 according to actual demand. In this example, when it needs to connect the generator 33 to the power supply bus 221 as the power supply 3 to supply power to the load 4 connected to the power supply bus 221 and supply power to the energy storage power supply (such as the battery module 32), the generator switch circuit 228 can be controlled to be switched on. Conversely, when it does not need to connect the generator 33 as the power supply 3 to the power supply bus 221 to supply power to the load 4 connected to the power supply bus 221 or supply power to the energy storage power supply, the generator switch circuit 228 can be controlled to be switched off.

As shown in FIG. 4, the generator switch circuit 228 includes a switch SW8. One end of the switch SW8 is connected to the generator 33, and the other end of the switch SW8 is connected to the power supply bus 221. When it needs to connect the generator 33 to the power supply bus 221 for power supply, the energy management module 21 can control the switch SW8 to be on. Conversely, when it does not need to connect the generator 33 to the power supply bus 221 for power supply, the energy management module 21 can control the switch SW8 to be off. In this example, the power supply circuit 22 further includes a capacitor C8, one end of the capacitor C8 can be connected to the generator 33, and the other end of the capacitor C8 can be connected to the switch SW4, so as to realize the function of DC blocking and AC passing.

In an embodiment, the energy management module 21 can communicate with the generator 33, and is configured to control the start and stop of the generator 33.

As an example, the energy management module 21 can also communicate with the generator 33, and when it needs to use the generator 33 as the power supply 3 to connect the power supply bus 221, the generator switch circuit 228 can be controlled to be switched on, and the generator 33 is controlled to start, so that the electric energy generated during working process of the generator 33 is transmitted to the power supply bus 221 through the generator switch circuit 228, thereby supplying power to the load 4 connected to the power supply bus 221 or the energy storage power source (such as the battery module 32). Conversely, when it does not need to use the generator 33 as the power supply 3 to connect the power supply bus 221, the generator switch circuit 228 can be controlled to be switched off, and the generator 33 can be controlled to stop working.

In an embodiment, as shown in FIG. 4, the power supply circuit 22 includes a power supply bus 221, a generator switch circuit 228 and a battery switch circuit 225. The input end of the generator switch circuit 228 can be connected to the generator 33, and the output end of the generator switch circuit 228 is connected to the power supply bus 221. The input end of battery switch circuit 225 can be connected to one or more battery modules 32, and the output end of battery switch circuit 225 is connected to power supply bus 221. The energy management module 21 can communicate with the generator switch circuit 228 and battery switch circuit 225 respectively and is configured to control the generator switch circuit 228 and battery switch circuit 225 to be switched on, so that the generator 33 can charge the battery module 32.

As an example, the input end of the generator switch circuit 228 can be connected to the generator 33, and the output end of the generator switch circuit 228 is connected to the power supply bus 221, so as to enable the generator 33 to output electric energy to the power supply bus 221. The input end of the battery switch circuit 225 can be connected with one or more battery modules 32, and the output end of the battery switch circuit 225 is connected with the power supply bus 221, so that the battery modules 32 can output power to the power supply bus 221 or receive power from the power supply bus 221. The energy management module 21 can communicate with the generator switch circuit 228 and battery switch circuit 225 respectively. When it needs to start the generator 33 to supply power to one or more battery modules 32 connected to the distribution box 2, the generator switch circuit 228 and the battery switch circuit 225 can be controlled to be switched on, so that the generator 33 can supply power to the one or more battery modules 32.

As shown in FIG. 4, the generator switch circuit 228 includes a switch SW8, one end of the switch SW8 is connected to the generator 33, and the other end of the switch SW8 is connected to the power supply bus 221. The battery switch circuit 225 includes a switch SW5, one end of the switch SW5 can be connected to one or more battery modules 32, and the other end of the switch SW5 is connected to the power supply bus 221. The energy management module 21 communicates with the switch SW8 and switch SW5, and can control the switch SW5 and switch SW8 to be on, so that the generator 33 can supply power to one or more battery modules 32.

In an embodiment, as shown in FIG. 4, the power supply circuit 22 includes a power supply bus 221, a generator switch circuit 228 and a load switch circuit 223. The input end of the generator switch circuit 228 can be connected to the generator 33, and the output end of the generator switch circuit 228 is connected to the power supply bus 221. The input end of the load switch circuit 223 is connected to the power supply bus 221, and the output end of the load switch circuit 223 can be connected to the load 4. The energy management module 21 can communicate with the generator switch circuit 228 and load switch circuit 223 respectively, and is configured to, control the generator switch circuit 228 and load switch circuit 223 to be switched on, so that the generator 33 can supply power to the load 4.

As an example, the input end of the generator switch circuit 228 can be connected to the generator 33, and the output end of the generator switch circuit 228 is connected to the power supply bus 221, so as to enable the generator 33 to output electric energy to the power supply bus 221. The input end of the load switch circuit 223 is connected to the power supply bus 221, and the output end of the load switch circuit 223 can be connected to the load 4, so that the load 4 can receive electric energy from the power supply bus 221. The energy management module 21 can communicate with the generator switch circuit 228 and load switch circuit 223 respectively. When it needs to start the generator 33 to supply power to the load 4 connected to the distribution box 2, the generator switch circuit 228 and load switch circuit 223 can be controlled to be switched on, so that the generator 33 can supply power to one or more loads 4.

As shown in FIG. 4, the generator switch circuit 228 includes a switch SW8, one end of the switch SW8 is connected to the generator 33, and the other end of the switch SW8 is connected to the power supply bus 221. The load switch circuit 223 includes a switch SW8, one end of the switch SW8 can be connected to one or more loads 4, and the other end of the switch SW8 is connected to the power supply bus 221. The energy management module 21 communicates with the switch SW8 and switch SW5, and can control the switch SW5 and switch SW8 to be on, so that the generator 33 can supply power to one or more loads 4.

In an embodiment, as shown in FIG. 4, the power supply circuit 22 includes a power supply bus 221, a main switch circuit 227, a standby switch circuit and a standby load branch. The input end of main switch circuit 227 can be connected to the main electricity grid 34, and the output end of the main switch circuit 227 is connected to the power supply bus 221. The input end of the standby switch circuit can be connected with a standby power supply, and the output end of the standby switch circuit is connected with the power supply bus 221. The input end of the standby load branch is connected with the power supply bus 221, and the output end of the standby load branch can be connected with a standby load. The energy management module 21 can communicate with the main switch circuit 227, standby switch circuit and standby load branch respectively, and is configured to, control the main switch circuit 227 to be switched off, and the standby switch circuit and standby load branch to be switched on, so that the standby power supply can supply power to the standby load.

The standby power supply refers to the power supply other than the main electricity grid 34. The standby switch circuit is used to connect the standby power supply. For example, when the standby power supply is photovoltaic device 31, the standby switch circuit is photovoltaic switch circuit 224. For another example, when the standby power supply is battery module 32, the standby switch circuit is battery switch circuit 225; For another example, when the standby power supply is generator 33, the standby switch circuit is generator switch circuit 228. The standby load branch refers to: the branch on which the load 4 powered by the standby power supply is located may be used when the main electricity grid 34 is disconnected. The standby load refers to the load 4 powered by the standby power supply.

As an example, the input end of the main switch circuit 227 can be connected to the main electricity grid 34, and the output end of the main switch circuit 227 is connected to the power supply bus 221, so as to supply power to the load 4 by the main electricity grid 34. The input end of the standby switch circuit can be connected with the standby power supply, and the output end of the standby switch circuit is connected with the power supply bus 221 to supply power to the load 4 through the standby power supply. The input end of the standby load branch is connected to the power supply bus 221, and the output end of the standby load branch can be connected to the standby load, and power can be supplied to the standby load through the power supply bus 221. The energy management module 21 can communicate with the main switch circuit 227, standby switch circuit and standby load branch respectively, and control the main switch circuit 227 to be switched off, and the standby switch circuit and standby load branch to be switched on, so as to enable the standby power supply to supply power to the standby load after the main electricity grid 34 is powered off.

As shown in FIG. 4, there is a standby load branch in the power supply circuit 22, the input end of the standby load branch is connected to the power supply bus 221, and the output end of the standby load branch is a Backup-port, which can be used to connect the standby load. After the main electricity grid 34 loses power, the main switch circuit 227 can be controlled to be disconnected, so that the main electricity grid 34 does not supply power to the standby load branch. Accordingly, the standby switch circuit and standby load branch can be controlled to be switched on, so that the standby power supply such as photovoltaic device 31, battery module 32 and generator 33 can supply power to the standby load.

In an embodiment, the power supply circuit 22 includes a power supply bus 221, a main switch circuit 227 and a non-standby load branch. The input end of the main switch circuit 227 can be connected to the main electricity grid 34, and the output end of the main switch circuit 227 is connected to the power supply bus 221. The input end of the non-standby load branch is connected with the power supply bus 221, and the output end of the non-standby load branch can be connected with the non-standby load. The energy management module 21 can communicate with the main switch circuit 227 and the non-standby load branch respectively, and is configured to, control the non-standby load branch to be turned on if the main switch circuit 227 is on; control the non-standby load branch to be turned off if the main switch circuit 227 is off.

The standby power supply refers to the power supply other than the main electricity grid 34. The standby switch circuit is used to connect the standby power supply. The non-standby load branch refers to: the branch on which the load 4 powered by the standby power supply is located cannot be used when the main electricity grid 34 is disconnected. The standby load refers to the load 4 powered by the standby power supply.

As an example, the input end of the main switch circuit 227 can be connected to the main electricity grid 34, and the output end of the main switch circuit 227 is connected to the power supply bus 221, so as to supply power to the load 4 by the main electricity grid 34. The input end of the non-standby load branch is connected to the power supply bus 221, and the output end of the non-standby load branch can be connected to the non-standby load, and power can be supplied to the non-standby load through the power supply bus 221. The energy management module 21 can communicate with the main switch circuit 227 and non-standby load branch respectively. If the main switch circuit 227 is on, the non-standby load branch is controlled to be turned on, so that the main electricity grid 34 can supply power to the non-standby load. If the main switch circuit 227 is off, the non-standby load branch is controlled to be turned off, so that the non-standby load is powered off after the main electricity grid 34 is powered off.

As shown in FIG. 4, the power supply circuit 22 is provided with a non-standby load branch, and the input end of the non-standby load branch is connected with the power supply bus 221. The output end of the standby load branch is a Non-backup port, which can be used to connect the non-standby load. When the main switch circuit 227 is on, the main electricity grid 34 can be controlled to supply power to the non-standby load. When main switch circuit 227 is disconnected, the non-standby load branch is controlled to be disconnected without using the standby power supply to supply power to the non-standby load.

In practical application, according to the needs of users, some loads 4 may be connected to the Backup-port, which is determined as standby load, and some loads 4 may be connected to the Non-backup port, which is determined as non-standby load. For example, when the distribution box 2 is for applicable power to the household load 4. The important load 4 that needs standby power can be connected to the Backup-port and determined as the standby load.

In an embodiment, as shown in FIG. 4, the power supply circuit 22 includes a power supply bus 221 and an electric vehicle charging circuit 229. The input end of the electric vehicle charging circuit 229 is connected with the power supply bus 221, and the output end of the electric vehicle charging circuit 229 is connected with an electric vehicle. The energy management module 21 communicates with the electric vehicle charging circuit 229, and is configured to control the on-off of the electric vehicle charging circuit 229.

The electric vehicle charging circuit 229 is a switch circuit for connecting electric vehicles.

As an example, the input end of the electric vehicle charging circuit 229 is connected to the power supply bus 221, and the output end of the electric vehicle charging circuit 229 is connected to the electric vehicle, so as to determine whether to output the electric energy of the power supply bus 221 to the electric vehicle. The energy management module 21 can communicate with the electric vehicle charging circuit 229. When the electric vehicle needs to be charged, the electric vehicle charging circuit 229 can be controlled to be switched on, so that one or more power supplies 3 connected to the distribution box 2 can supply power to the electric vehicle. When the electric vehicle does not need to be charged, the electric vehicle charging circuit 229 can be controlled to be switched off.

As shown in FIG. 4, the electric vehicle charging circuit 229 includes a switch SW9. One end of the switch SW9 is connected to an electric vehicle, and the other end of the switch SW9 is connected to the power supply bus 221. When the electric vehicle needs to be charged, the energy management module 21 can control the switch SW9 to be on. Conversely, when the electric vehicle does not need to be charged, the energy management module 21 can control the switch SW9 to be off. In this example, the power supply circuit 22 also includes a capacitor C9. One end of the capacitor C9 can be connected to the electric vehicle, and the other end of the capacitor C9 can be connected to a switch SW9, so as to realize the function of DC blocking and AC passing.

In an embodiment, as shown in FIG. 4, the power supply device further includes an intelligent load box 23. The input end of the intelligent load box 23 is connected to the distribution box 2, and the output end of the intelligent load box 23 can be connected to the load 4. And the intelligent load box 23 is configured to control power supply of the load 4. The intelligent load box 23 is a device for controlling the load 4.

As an example, the power supply device further includes an intelligent load box 23. The input end of the intelligent load box 23 is connected to the distribution box 2, and the output end of the intelligent load box 23 can be connected to the load 4, so as to supply power to the load 4 connected to the intelligent load box 23 through the distribution box 2. In this example, the load 4 connected to the intelligent load box 23 may be the load 4 that needs to be controlled in the home or the load 4 that needs to be controlled remotely. For example, the intelligent load box 23 can be connected with an air conditioner. When the air conditioner is in use, it can be controlled to turn on by remote control or APP, and then electric energy output by the distribution box 2 can be used to supply power to the air conditioner through the intelligent load box 23. For another example, when the main electricity grid 34 is powered off and the power capacity supplied by the standby power supply is low, the load 4 connected to the intelligent load box 23 can be controlled to lose power through remote control or APP to ensure the continuous power supply of other standby loads.

As an example, the intelligent load box 23 can be connected to an electric vehicle or other loads 4 that need to be charged. When such loads 4 need to be charged are connected, the charging information can be set independently. For example, the charging can be set regularly, the charging amount can be monitored and the charging duration can be selected independently to meet various charging requirements.

As an example, the intelligent load box 23 can receive other standby power supplies except the main electricity grid 34. For example, it can receive AC sources such as generator 33 and the V2L port of electric vehicle, so as to reserve power for the household load 4 in an emergency and realize flexible multi-source access.

Understandably, the power supply device can be composed of switch circuits corresponding to one or more connection functions in the above-mentioned embodiments, switch circuits corresponding to one or more connection functions, and power supply 3 or load 4 connected to the switch circuits, so as to form a power supply system. Each switch circuit includes an idle switch and a relay. According to the actual situation, it can be determined whether there is only an idle switch or only a relay to meet different requirements.

In an embodiment, a power supply system is provided, including a distribution box 2, a power fusion system 1 and at least one battery module 32. The distribution box 2 is connected with the power fusion system 1 and battery module 32. The power fusion system 1 includes a control unit 11, at least one power conversion unit 12 and a DC/AC unit 13. The power conversion unit 12 is configured to convert the current output by the power supply 3 into DC. The DC/AC unit 13 is connected to all installed power conversion units 12, and is configured to convert DC output by one or more power conversion units 12 into AC to meet power supply demand. The control unit 11 communicates with all installed power conversion units 12 and DC/AC unit 13, and is configured to control the operation of one or more power conversion units 12 and DC/AC unit 13. The distribution box 2 is configured to determine power supply demand, and allocate the power supply 3 connected to the power fusion system 1 and the battery module 32 to supply power to the load 4 separately or jointly according to the power supply demand.

As an example, the power supply system includes a distribution box 2, a power fusion system 1 connected to the distribution box 2 and at least one battery module 32. The power fusion system 1 includes a control unit 11, at least one power conversion unit 12 communicating with the control unit 11, and a DC/AC unit 13. The power conversion unit 12 can convert the current output by one or more power supplies 3 into the DC required by the DC/AC unit 13, and then the DC/AC unit 13 converts the DC into the AC meeting the power supply demand to supply power to the load 4. In this example, the distribution box 2 can determine the power supply demand of all the loads 4 according to the loads 4 connected to the distribution box 2, and can allocate one or more power supplies 3 connected to the power fusion system 1 to supply power to the loads 4 independently according to the power supply demand, or allocate one or more battery modules 32 connected to the distribution box 2 to supply power to the load 4, or allocate the power supply 3 and battery modules 32 to jointly supply power to the load 4.

As an example, the power supply system can be applied to the case of supplying power to household load 4, including one or more power supplies 3 and distribution box 2. That is, one or more of the power supplies 3, such as main electricity grid 34, photovoltaic device 31, battery module 32 and generator 33, can be connected to the distribution box 2, and the connected load 4 is supplied with power through the distribution box 2.

As an example, the power supply system can be applied to the case of supplying power to household load 4, including one or more power supplies 3, power fusion system 1 and distribution box 2. That is, one or more of the power supplies 3, such as main electricity grid 34, photovoltaic device 31, battery module 32 and generator 33, can be connected to the power fusion system 1, and then the power fusion system 1 is connected to the distribution box 2 to supply power to the connected load 4 through the distribution box 2.

As an example, in the power supply system, the uncontrollable power supply 3 can be connected to the power fusion system 1 according to the power supply demand, and after passing through the power fusion system 1, the currents output by various power supplies 3 can be converted into AC that meets the power supply demand, so as to convert the uncontrollable power supply 3 into a controllable power supply 3 that can be managed and dispatched to supply power to the household load 4.

As an example, the power supply system may include a distribution box 2, a distribution box 2 and a power fusion system 1 and may further include a distribution box 2 and a battery module 32. Then the distribution box 2 may be connected to one or more external devices, for example, one or more loads 4.

As an example, in the power supply system, the distribution box 2 is an energy management center, which is used to realize the connection and management of the power supply 3, and the connection and management of the load 4.

As an example, in the power supply system, the distribution box 2 can support the connection of main electricity grid 34, photovoltaic device 31, battery module 32, generator 33, electric vehicle, intelligent load box 23 and power fusion system 1, and it can be composed of partial connection of the above or more power supplies 3.

As an example, in the power supply system, the distribution box 2 is internally provided with an energy management module 21, which has functions of communication (wired communication and wireless communication), other source access control, fault detection and energy coordination, etc.

As an example, in the power supply system, the distribution box 2 can not only support the direct access of one or more power supplies 3, but also support the indirect access of one or more power supplies 3. For example, the indirect access through the power fusion system 1 or the regulated access through other inverters. Understandably, the combination of the distribution box 2 and power fusion system 1 can ensure the flexibility of the power supply system to access the power supply 3.

As an example, in the power supply system, the distribution box 2 can realize the active off-grid function, that is, it can be set by the user independently, and the main electricity grid 34 can be actively disconnected from the power supply system, and other power supplies 3 can be used to form a home microgrid. For example, the home microgrid is composed of a photovoltaic device 31, battery module 32, generator 33 and power fusion system 1, and the power supply 3 in the home microgrid can be used for power supply alone or jointly.

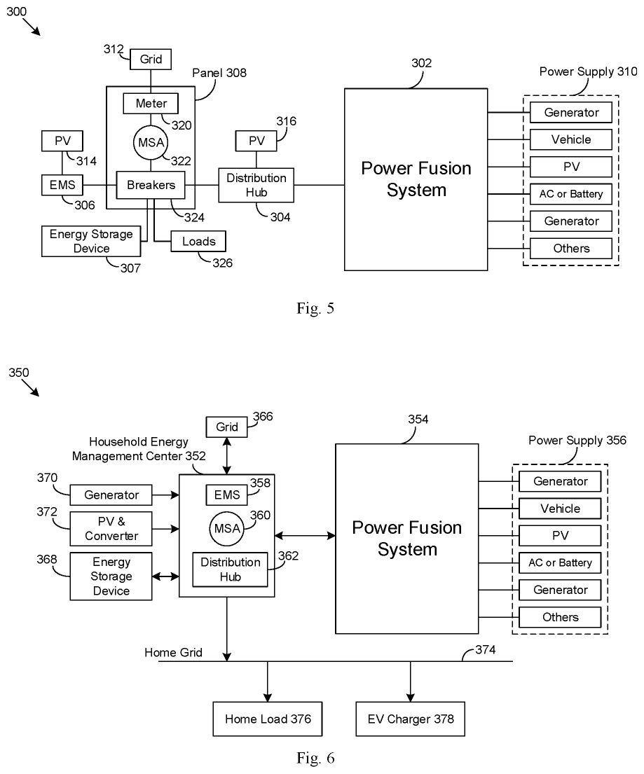

FIG. 5 illustrates a schematic diagram of a household power supply system 300 in accordance with various embodiments of the present disclosure. The household power supply system 300 includes a power fusion system 302 and a distribution hub 304, providing a power supply solution for a household. The household power supply system 300 further includes a connection to a utility grid 312, PV panels, PV inverters, and generators (e.g., standby and/or portable generators). As used herein, the term “utility grid” indicates a public power supply network. The power fusion system 302 may integrate power from various power sources. As used herein, the terms “power source” and “power supply source” are exchangeable and both indicate a power supply source with DC or AV output. The household power supply system 300 resolves difficulties of integrating various power sources at a home, addresses long-term backup power needs during extreme weather, solves mismatches between different power sources, and tackles issues of multiple sources not being able to supply power simultaneously and cooperatively. It improves access of household power supply, enhances the compatibility and adaptability of different power supply sources, and improves the household electricity usage experience.

Optionally, the power fusion system 302 connects to the distribution hub 304 through a single interface or a small number of interfaces, effectively reducing the size and cost of the distribution hub 304, and improving product connection flexibility. The power fusion system 302 may also offer connection options for a user to choose.

The power fusion system 302 contains a control unit (not shown), multiple power conversion units (not shown), and a DC/AC unit (not shown). Optionally, the control unit may have the same structure as or a similar structure to that the control unit 11 as shown in FIG. 1, the power conversion units may have the same structure as or a similar structure to that of the power conversion units 12 as shown in FIG. 1, and the DC/AC unit may have the same structure as or a similar structure to that of the DC/AC unit 13 as shown in FIG. 1. Optionally, the power conversion units and the DC/AC unit of the power fusion system 302 may form multiple power supply modules that serve as current sources and/or voltage sources, respectively. Optionally, the power supply modules may respectively input AC or DC power and respectively output AC power that matches requirements of a household, i.e., converting AC power into required AC power and inverting DC power into the required AC power.

These power supply modules may include a unidirectional output module and/or a bidirectional output module. A user may select the number of the power supply modules according to actual needs. For example, if a user wants to connect DC power generated from PV panels to the power fusion system 302, the user may choose a power supply module of a corresponding function and capability. If a user wants to connect AC power (such as from a power supply of a vehicle through the vehicle-to-home (V2H) or vehicle-to-load (V2L) technology), the user may choose to add a power supply module to the power fusion system 302 to connect with the AC power. There is no limit to the number of the power supply modules at the power fusion system 302. Various sources connected at the power fusion system 302 may work simultaneously, providing power supply security for a household.

Optionally, the distribution hub 304 contains an energy management module (not shown) and power supply circuits (not shown) that may be the same as or similar to the energy management module 21 and power supply circuit 22 shown in FIG. 3. For example, the power supply circuits may include various switches used for connecting, disconnecting, and scheduling a power supply source. The switches may be mechanical switches or electronic switches, with no restriction on the switch types.

The household power supply system 300 further includes an energy management system (EMS) module 306, an energy storage device 307, a panel 308, and a power supply 310. The EMS module 306 and the energy storage device 307 are connected to the panel 308, respectively. The distribution hub 304 is connected to the power fusion system 302 and the panel 308, respectively. The power supply 310 is connected to the power fusion system 302.

The EMS module 306 is an energy management device and used for managing and scheduling electricity consumption and power sources at a household. The EMS module 306 communicates with other devices at the household power supply system 300 through wired and/or wireless communication. Additionally, an APP or web interface of the EMS module 306 may be arranged on a user end, allowing settings and control through remote or desktop operations by a user.

The energy storage device 307 includes a battery module (e.g., a battery pack) (not shown) and a power conversion system (PCS) (not shown) for home energy storage. The battery module includes energy storage units. The PCS includes inverter units. The energy storage device 307 may manage the charging and discharging of the energy storage units, and communicate with the EMS module 306 to accept energy scheduling and management instructions from the EMS module 306. The AC output of the energy storage device 307 may serve as a current source or a voltage source.

The panel 308 includes an electricity meter 320, a meter socket adapter (MSA) 322, and circuit breakers 324. The electricity meter 320 is inserted in the MSA 322, while the MSA 322 is inserted in a meter socket and installed at the bottom of the electricity meter 320. The MSA 322 communicates with the EMS module 306 through a wired or wireless method, with no restriction here. A user may connect important household loads or certain loads requiring special management to the MSA 322 through a connection port or connection interface of the MSA 322. The user may remotely manage the loads and other devices at the household power supply system 300 via an APP or web interface of the MSA 322. The EMS module 306 may also perform intelligent control based on current or future power supply demands. Optionally, the EMS module 306, the energy storage device 307, and loads 326 may be connected to the panel 308 or the MSA 322 to get connected with the household power supply system 300.

The power supply 310 may include one or more of power supply sources, such as a generator, an electric vehicle, a PV system, a suitable AC source, a battery module, and other suitable power sources. Optionally, when a user connects a generator to the power fusion system 302, the EMS module 306 may automatically manage the generator, controlling start and stop of the generator, and automatically adjust the output of the generator based on the household electricity demand.

The distribution hub 304 supports connection to an electric vehicle that may provide AC power and DC power. An electric vehicle may be connected to the power fusion system 302. The distribution hub 304 is arranged to detect charging/discharging current and power of the electric vehicle, and adjust the electric vehicle's charging functions based on available power supply capacity.

Optionally, a user may connect the utility grid 312 to the electric meter 320 and MSA 322. The EMS module 306 monitors and regulates the grid power usage according to prearranged settings by the user, aiming to maximize the use of household green energy, maximize benefits, and help the user achieve maximum electricity freedom. As such, dependence on the utility grid 312 may be reduced.

The energy storage device 307 may be utilized as a voltage source in a black start process. The black start is arranged for restoring electricity after the household power supply system 300 exits a sleep mode. Whether the PV power is weak or strong, the EMS module 306 may charge batteries through coordinated control of the switches in the distribution hub 304. As an example, the EMS module 306 may disconnect the household loads 326 before a black start process is performed. The energy storage device 307 may act as a voltage source to help start PV inverters and improve PV power utilization. Further, PV systems 314 and 316 connected respectively to the EMS module 306 and the distribution hub 304 may also be used as power sources in a black start process.

The household power supply system 300 provides a method to connect to multiple power sources. Compared to conventional methods that involve directly connecting multiple sources to a home grid or a utility grid, the household power supply system 300 connect them controllably to a home grid or utility grid through the power fusion system 302. Further, conventional connection methods only accommodate one voltage source, with others being current sources. The household power supply system 300 allows multiple voltage sources to be connected simultaneously.

FIG. 6 illustrates a schematic diagram of a household power supply system 350 in accordance with various embodiments of the present disclosure. As shown above and below, some embodiments are illustrated in FIG. 5 or 6, while some other embodiments are not described in FIG. 5 or 6 and in some cases, are different from that depicted in FIG. 5 or 6. As shown in FIG. 6, the household power supply system 350 includes a household energy management center 352, a power fusion system 354, and a power supply 356. The household energy management center 352 includes an EMS module 358, an MSA 360, an electric meter (not shown) inserted in the MSA 360, and a distribution hub 362 that are interconnected with each other. Similar to the power fusion system 302 shown in FIG. 5, the power fusion system 354 integrates power from various power sources.

The power fusion system 354 contains a control unit (not shown) and multiple power supply modules (not shown). Optionally, the control unit and power supply modules of the power fusion system 354 may have the same structures as or similar structures to that of the control unit and power supply modules of the power fusion system 302, respectively. Similarly, the power supply modules of the power fusion system 354 may be current sources or voltage sources. Optionally, the power supply modules may input AC or DC power and output AC power matching requirements of a household. These power supply modules may include unidirectional output modules and/or bidirectional output modules. The power supply 356 includes one or more of power supply sources, such as a generator, an electric vehicle, a PV system, an AC source, a battery module, and other suitable power supply sources.

Similar to the EMS module 306, the EMS module 358 is an energy management center and used for energy managing and scheduling. The EMS module 358 communicates with other devices at the household power supply system 350 through wired and/or wireless communication. Additionally, an APP or web interface of the EMS module 358 may be arranged on a user end, allowing settings and control through remote or desktop operations by a user.

Similar to the distribution hub 304, the distribution hub 362 contains an energy management module (not shown) and power supply circuits (not shown) that may be the same as or similar to the energy management module 21 and power supply circuit 22 shown in FIG. 3. Optionally, the power supply circuits at the distribution hub 362 may include various switches used for connecting, disconnecting, and scheduling power supply sources (e.g., the power sources at the power supply 356). The MSA 360 may have the same functions and capabilities as that of the MSA 322 described above. The distribution hub 362 or its power supply circuits may have built-in on/off control switches and safety protection switches in connection paths of the power sources at the power supply 356, with each on/off switch being controllable. Further, some power supply circuits may have functions such as current detection, voltage detection, energy statistics, and reverse flow prevention for detection and monitoring of the power sources.

In some embodiments, the household power supply system 350 receives power from AC power sources, such as a utility grid 366, an energy storage device 368, a generator 370, a PV & converter system 372, and/or a power source of the power supply 356 (e.g., the generator, PV system, or electric vehicle). The utility grid 366, energy storage device 368, generator 370, and PV & converter system 372 are connected to the household energy management center 352, e.g., through the MSA 360 or the distribution hub 304. The power fusion system 354 is connected to the household energy management center 352 (e.g., through the distribution hub 362) and the power supply 356, respectively. The load side of the power fusion system 354 includes main output, which may be connected to the distribution hub 362 or directly to a home load 376 and an EV charger 378 (i.e., an electric vehicle supply equipment (EVSE)) exemplarily. The switches at the distribution hub 362 may include smart load switches, which may be connected to a regular load or a high-power load. A user may use smart load switches to flexibly and remotely control the loads.

Optionally, the EMS module 358 may be connected and communicate to the power fusion system 354 and the distribution hub 362 directly. The EMS module 358 may also communicate with and control some power sources at the power supply 356 directly. If some other power sources at the power supply 356 lack communication capability, these other power sources may be controlled by switches and get connected after phase-locking. Communication conducted by the EMS module 358 may be wired or wireless. The EMS module 358 may control the power supply capability of the power sources at the power supply 356 through information exchange directly or, in some cases, through certain source control devices. If a power source at the power supply 356 is uncontrollable or communication with it fails, the household energy management center 352 (or the EMS module 358) may disconnect the power source by shutting off a switch to ensure electricity safety of the household.

The household energy management center 352 has management and monitoring capabilities for the power sources at the power supply 356. When a device fault or a load-side fault is detected at a power source, the household energy management center 352 may first instruct the faulty device to isolate itself via communication. Optionally, the household energy management center 352 may cut off the power source or the load by disconnecting its access switch, thereby removing the faulty power source or load from the household power supply system 350 to ensure electricity safety and equipment safety.

The utility grid 366 may be connected through a contactor at the MSA 360. The contactor capacity may be configured according to internal loads of the household. The EMS module 358 may schedule connection of the utility grid 366 through the MSA module 360. When the utility grid 366 is available, the contactor may be turned on in some cases and turned off in so other cases. For example, if the energy from the energy storage device 368 and the PV & converter system 372 is sufficient, the utility grid 366 may be automatically disconnected. If there is grid power outage, the utility grid 366 is also disconnected, and backup power sources may supply power to the household. During grid power outage, the contactor at the MSA may be turned off, and power sources at the household power supply system 350 may be utilized to ensure power supply of the household.

When the utility grid 366 is available, if the household green energy (e.g., the energy from a PV system or the energy storage device 368) can supply power, the EMS module 358 may schedule to use the green energy based on the power level of the green energy and the loads. For example, the EMS module 358 may schedule the green energy power based on the household load size. The green energy power may be scheduled via communication remotely via the EMS module 358. The EMS module 358 may cut off the supply current of the utility grid 366 to the household, and simultaneously stop the household green energy from going to the utility grid 366. Further, the EMS module 358 has current collection functions and green energy power scheduling functions. In some embodiments, the EMS module 358 uses certain algorithms to ensure the household green energy is not transmitted to the utility grid 366.

If a user chooses to allow grid feedback, the EMS module 358 may control the PV power generation or excess energy to feed back to the utility grid 366. The utility grid 366 may get as much energy as the PV systems at the household power supply system 350 generates in some cases.

If the utility grid 366 is off, the grid connection may be shut off, leaving that path vacant. Optionally, the utility grid 366 may be disconnected by a switch. Alternatively, after a user enables an off-grid mode through an APP, the household energy management center 352 (or the EMS module 358) may cut off the power supply of the utility grid 366.

In some embodiments, a PV connection interface may be configured at the distribution hub 362. Optionally, the energy storage device 368 may be connected to the distribution hub 362 or a distribution box (not shown). In some cases, only one connection path is configured for certain power source. Optionally, the distribution hub 362 and energy storage device 368 each may have one or multiple connection paths. In some embodiments, one connection path may be expanded to multiple connection paths by switches. After expansion, the multiple connection paths may be supported and controlled individually or in groups by the EMS module 358.

As shown in FIG. 6, the EMS module 358 may be connected with the energy storage device 368 and the PV & converter system 372. Similar to the energy storage device 307, the energy storage device 368 includes a battery module (not shown) and a PCS (not shown). The battery module includes energy storage units. The PCS includes inverter units. The energy storage device 368 may manage the charging and discharging of the energy storage units, and communicate with the EMS module 358 to accept energy scheduling and management instructions from the EMS module 358. Optionally, the energy storage device 368 may have AC output and serve as a current source or a voltage source.

In some embodiments, the EMS module 358 may use the energy storage device 368 and the PV & converter system 372 to implement a black start process. The EMS module 368 may, according to certain strategy, shut off control switches for the home load 376 and the EV charger 378, and then use the energy storage device 368 as a voltage source to power the startup of the PV & converter system 372. Further, the PV system at the power supply 356 may be turned on. Further, the energy storage device 368 and the battery module at the power supply 356 may be charged when there is sunlight. It reduces PV startup difficulties under certain conditions (e.g., when the load is relatively heavy, the PV power is weak, the utility grid 366 is out, and the energy storage device 368 cannot supply power to the household under load).

In some embodiments, the EMS module 358 may use the energy storage device 368 and the generator 370 to carry out a black start process. The EMS module 368 may shut off the control switches for the home load 376 and the EV charger 378, and then use the energy storage device 368 to power the generator 370 to start. Further, the PV system at the power supply 356 may be turned on using the power from the generator 370. The energy storage device 368 and the battery module at the power supply 356 may be charged when there is sunlight.

In some embodiments, one or more generators at the power supply 356 are connected to the household power supply system 350 through the power fusion system 354. Optionally, the EMS module 358 may control the connection and disconnection of the generators at the power supply 356 by controlling corresponding power supply modules of the power fusion system 354. For example, control signals for the generators may be managed by the EMS module 358. The EMS module 358 may control the start and stop of the generators. Optionally, the EMS module 358 may create control strategies for the generators at the power supply 356 based on the system's electrical energy situation. After the generators get started, the generators may supply power to the home load 376 and simultaneously charge the energy storage device 368.

Optionally, the household power supply system 350 includes a backup port and a non-backup port. A load of the home load 376 may be connected to the backup port as a household backup load. The household backup load may be powered by backup power sources such as the PV system, the energy storage device 368, and the generators during outage of the utility grid 366.

Further, a load of the home load 376 may be connected to the non-backup port as a non-backup load. The non-backup load may only be powered when the utility grid 366 is available. When the utility grid 366 is out, the non-backup load is powered off. As such, some loads of the home load 376 are connected to the backup port and some other loads to the non-backup port according to actual needs. For example, certain important loads that require backup power are connected to the backup port.

Further, certain smart load connection may be arranged for the household power supply system 350. The smart load connection may include connection ports, such as Port 1, Port 2, and Port 3 for different loads of the home load 376 to connect to. Ports 1-3 may be connected to the distribution hub 362, the household management center 352, the MSA 360, or a smart load box (not shown) connected with the household management center 352.

Port 1 is configured for certain loads that need to be controlled in the household or may be remotely controllable. Port 1 is also configured for some special loads that can be connected to Port 1. The smart load connection may be controlled by a user. For example, a user may turn on an air conditioner remotely before returning home. During outage of the utility grid 366, when the backup power is low, a user may control Port 1 to shut off loads connected to Port 1. It ensures that certain backup loads may continue to be powered.

Port 2 is used to connect loads such as an electric vehicle. Charging of the electric vehicle may be scheduled and monitored via Port 2. Further, the charging power may be detected and the charging time may be selected through Port 2.

Port 3 is used to connect some backup power sources, such as a small generator, a V2L port of an electric vehicle, or other AC sources. These backup power sources may provide household backup power in emergencies, enabling flexible multi-source connection.

In some embodiments, the power fusion system 354 is connected to the household power supply system 350 through the distribution hub 362. The EMS module 358 may communicate and exchange data with the power fusion system 354. The EMS module 358 may also schedule power output at the power fusion system 354. In some cases, e.g., in emergencies, the EMS module 358 may control connection of the power fusion system 354 through internal switches at the distribution hub 362, or cut off power supply of a circuit when a fault is detected, ensuring the household electricity safety.

Optionally, the EMS module 358 may be the control core of the household power supply system 350. The EMS module 358 includes a communication interface (e.g., including but not limited to CAN communication, RS485 communication, WLAN communication, and Wi-Fi, 4G), a relay control interface, and a relay detection interface. Optionally, the EMS module 358 may perform grid voltage detection, circuit detection, current and voltage detection for each input and output branch, strategy logic control, etc.

As the core of energy scheduling, the EMS module 358 may be used for management and control of the entire household power supply system, formulating reasonable energy scheduling and management strategies based on household demands.

In some embodiments, the distribution hub 362 may include one or more connection functions that may be similar to some of the above-mentioned connection functions. Optionally, some connections may form a connection system at the distribution hub 362. Further, the distribution hub 362 may have connection branches. Each of the connection branches may be controlled by a relay.

Optionally, main functions of the power fusion system 354 may include: Solving problems of mismatch between various power supply sources, integrating various available power sources such as the energy storage device 368 and the power sources of the power supply 356 (e.g., the generator, vehicle, PV system, and battery module), connecting available power sources to the distribution hub 362 through standard power supply modules, performing energy management and scheduling via the EMS module 358, using different power sources to supply power to the household simultaneously, and ensuring power source diversity.

Further, the power fusion system 354 may be used to solve the following problems: Difficulties of connection with various power sources in the household, needs of long-term backup power during extreme weather situations, mismatches between different power sources, and issues of multiple power sources being unable to supply power simultaneously and cooperatively. It provides broader access for household power sources, improves the compatibility and adaptability of different power sources, and enhances the household electricity usage experience.

In some embodiments, the power supply modules of the power fusion system 354 are essential components. A user may choose the number of the power supply modules according to actual needs. These power supply modules support input of AC source or DC source, and have a built-in isolation function, which is not restricted by safety regulation requirements. Optionally, the power supply module includes an isolation structure made of isolation materials. The isolation structure provides the built-in isolation function arranged to electrically isolate one power supply module from another power supply module. A user may flexibly use the power supply modules based on types of power sources available in the household.

The control unit of the power fusion system 354 may perform scheduling and coordination for the power supply modules. The control unit may also perform various electrical protection functions, such as adjusting power, reasonably selecting power sources, cutting off known faulty equipment, etc.

Optionally, the power fusion system 354 may be used as a current source or a voltage source. The power fusion system 354 may also be used based on a schedule or have power self-adaptation functions.

Optionally, an input source of the power fusion system 354 may be a DC source (e.g., a PV system, a battery module, or fuel cells) or an AC source (e.g., a generator, wind power, or a V2H or V2L port of a vehicle).

Optionally, an input port of the power fusion system 354 may have a modularization design. A user may select the number of the power supply modules based on actual types of connected power sources.

Optionally, input sources of the power fusion system 354 may work collectively or independently to supply power to a household. When the energy from one connected power source cannot meet the household electricity demand, the power fusion system 354 may automatically start other connected power sources, using multiple sources jointly to supply power to the home load 376.

Optionally, the power supply modules of the power fusion system 354 may have bidirectional operation characteristics. The power supply modules may have bidirectional energy flow capabilities. When a connected power source has energy storage units, the power fusion system 354 may charge the energy storage units of the connected source using the utility grid 366 or other power sources, and manage these energy storage units.

Optionally, the power fusion system 354 may have a cut-off function to disconnect a power source or a power supply module. When detecting a fault in a power source, the power fusion system 354 may disconnect the power source. When detecting a fault in a power supply module, the power fusion system 354 may bypass or isolate that faulty power supply module without affecting power supply of other modules and the system operation.

Optionally, the output of the power supply modules of the power fusion system 354 may be connected to a common AC bus. In some cases, outputs of the power supply modules may be connected in parallel, enabling multiple power sources to supply power simultaneously.

Optionally, the internal control and scheduling functions of the power fusion system 354 may be coordinated and controlled by the control unit.

In some embodiments, the household power supply system 350 may be formed by a power source (e.g., the utility grid 366, a generator, a PV system, or the energy storage device 368) and an energy management center, such as the household energy management center 352.

Optionally, the household power supply system 350 may be formed by the power fusion system 354, one or more power sources, and the household energy management center 352.

In some embodiments, some power sources are in operation but not communicatively connected in a household and cannot be controlled remotely. Optionally, these power sources may be connected to the power fusion system 354 and converted into controllable sources that may be managed and scheduled to supply power to the household by the power fusion system 354.

In some embodiments, the household power supply system 350 may be formed by the household energy management center 352. Optionally, the household power supply system 350 may be formed by the household energy management center 352 and the power fusion system 354. Alternatively, the household power supply system 350 may be formed by the household energy management center 352 and the energy storage device 368. In some cases, the household power supply system 350 may be formed by the household energy management center 352 and one or more other devices.

As illustrated above, the household energy management center 352 includes the MSA 360. The MSA 360 may be used for connection and management of the utility grid 366. The MSA 360 may also be used for connection and management of the home load 376 connected with the distribution hub 362. Optionally, functions of the MSA 360 include connections of the utility grid 366, a PV inverter, a generator, the energy storage device 368, electric vehicle charging/discharging device, smart load equipment, the power fusion system 354, etc.

Optionally, the functions of the EMS module 358 include management, communication (e.g., wired and wireless communication), connection control of power sources, fault detection, power source coordination, etc.

In addition to direct connections of multiple power sources, the household energy management center 352 also supports indirect connections of some power sources (e.g., through the power fusion system 354, or after regulation by inverters).

Optionally, the household energy management center 352 may include a utility grid switch. The utility grid switch may be used to cut off connection of the utility grid 366 from the household power supply system 350. For example, a user may set to actively disconnect the utility grid 366 from the household power supply system 350. In some cases, the household power supply system 350 may be considered as a home grid or a micro grid. The home grid may include a power source, such as a PV system, the energy storage device 368, or a generator, and the power fusion system 354. The connected power sources may supply power jointly or independently. A bus 374 may be arranged to connect the distribution hub 362, the home load 376, and the EV charger 378.

As illustrated above, one or more power sources may be flexibly connected to a home grid through the power fusion system 354 and/or the household energy management center 352.

The above embodiments are only used to illustrate the technical solutions of the present application, but not to limit it. Although the present application has been described in detail with reference to the foregoing embodiments, those skilled in the art would understand that it is possible to modify the technical solutions described in the foregoing embodiments, or to replace some technical features with equivalents. However, these modifications or substitutions do not make the essence of the corresponding technical solutions deviate from the spirit and scope of the technical solutions of various embodiments of the present application, and shall be included in the protection scope of the present application. Further, unless otherwise required by context, singular terms shall include pluralities and plural terms shall include the singular.

What is claimed is:

1. A system of household power supply, comprising:
a power supply including one or more power supply sources;
a household energy management center including an energy management system (EMS) module, a meter socket adapter (MSA) including a connection port for connecting a load, an electric meter inserted in the MSA, and a distribution hub, the EMS arranged for managing and scheduling the one or more power supply sources, the distribution hub arranged for connecting or disconnecting the one or more power supply sources; and
a power fusion system connected to the household energy management center and the power supply, respectively and including a control unit and one or more power supply modules, and the one or more power supply modules arranged for converting alternating current (AC) power or direct current (DC) power into required AC power.

2. The system according to claim 1, further comprising:
an energy storage device including a battery module and a power conversion system (PCS).

3. The system according to claim 1, wherein the distribution hub comprises a control switch and/or a safety protection switch in a connection path of one of the one or more power supply sources.

4. The system according to claim 1, wherein the one or more power supply sources comprises at least one of a generator, a vehicle, a battery module, and a photovoltaic (PV) system.

5. The system according to claim 1, wherein the MSA is connected to a utility grid and the load and arranged with an application (APP) interface and/or a web interface.

6. The system according to claim 1, wherein the distribution hub comprises one or more functions of current detection, voltage detection, energy statistics, and reverse flow prevention for detection and monitoring of the one or more power supply sources.

7. The system according to claim 1, further comprising:
another connection port arranged for connecting another load and remotely controllable by a user.

8. A system of household power supply, comprising:
a power supply at least including an alternating current (AC) power supply source and a direct current (DC) power supply source;
an energy management system (EMS) module for managing and scheduling the AC and DC power supply sources;
a distribution hub for connecting or disconnecting the AC or DC power supply source; and
a power fusion system connected to the distribution hub and the power supply, respectively and including a control unit, a first power supply module, a second power supply module, and the first and second power supply modules arranged for converting AC power from the AC power supply source and DC power from the DC power supply source into required AC power, respectively.

9. The system according to claim 8, further comprising:
a meter socket adapter (MSA) including a connection port for connecting a load and a utility grid; and.
an electric meter inserted in the MSA.

10. The system according to claim 8, further comprising:
an energy storage device including a battery module and a power conversion system (PCS).

11. The system according to claim 8, wherein the distribution hub comprises a control switch and/or a safety protection switch in a connection path of one of the AC power supply source and the DC power supply source.

12. The system according to claim 8, wherein the AC power supply source includes at least one of a generator, a vehicle, and a photovoltaic (PV) system and the DC power supply source includes at least one of a battery module, the vehicle or another vehicle, and another PV system.

13. The system according to claim 8, wherein the distribution hub comprises one or more functions of current detection, voltage detection, energy statistics, and reverse flow prevention for detection and monitoring of the AC and DC power supply sources.

14. The system according to claim 8, further comprising:
a connection port arranged for connecting to a load and remotely controllable by a user.

15. A system of household power supply, comprising:
a power supply including one or more power supply sources;
an energy management system (EMS) module for managing and scheduling the one or more power supply sources and with an application (APP) interface and/or a web interface;
a distribution hub for connecting or disconnecting the one or more power supply sources;
an energy storage device including a battery module and a power conversion system (PCS); and
a power fusion system connected to the distribution hub and the power supply, respectively and including a control unit and one or more power supply modules, and the one or more power supply modules arranged for converting alternating current (AC) power or direct current (DC) power into required AC power.

16. The system according to claim 15, further comprising:
a meter socket adapter (MSA) including a connection port for connecting a load and a utility grid; and.
an electric meter inserted in the MSA.

17. The system according to claim 15, wherein the distribution hub comprises a control switch and/or a safety protection switch in a connection path of one of the one or more power supply sources.

18. The system according to claim 15, wherein the one or more power supply modules include a bidirectional power supply module.

19. The system according to claim 15, wherein the distribution hub comprises one or more functions of current detection, voltage detection, energy statistics, and reverse flow prevention for detection and monitoring of the one or more power supply sources.

20. The system according to claim 15, further comprising:
a connection port arranged for connecting to a load and remotely controllable by a user.
